(19) United States
(12) Patent Application Publication
(10) Pub. No.: US 2004/0044592 A1
(43) Pub. Date: Mar. 4, 2004

(54) Automated collection of vehicle data

(75) Inventors: Henry Thomas Ubik, Grosse Pte. Park, MI (US); Mona Patel, Canton, MI (US); Joseph Kowalski, Ann Arbor, MI (US); Anthony Joseph Cataldo, Clinton Twp., MI (US); Victor Joseph Kudyba, Northville, MI (US); Tom Bacon, St. Clair, MI (US)

Correspondence Address: KEVIN G. MIERZWA, ARTZ & ARTZ, P.C., 28333 TELEGRAPH ROAD, SUITE 250, SOUTHFIELD, MI, 48034, US

(73) Assignee: Ford Motor Company, Dearborn, MI

(21) Appl. No.: 10/064,964

(22) Filed: Sep. 4, 2002

(51) Int. Cl. G06F 17/60

(52) U.S. Cl. 705/28

(57) ABSTRACT

A method of inventory control at a service area site for transportation vehicles having an active RF transmitter connected to a service bus, whereby the service area site has a server in communication with the transmitter on the vehicle. The server automatically collects information from the vehicles relative to inventory management without the need for manual intervention. In another embodiment the inventory management method is expanded to include service management at a fleet or rental vehicle site.

### CROSS REFERENCE TO RELATED APPLICATIONS

The present invention is cross-referenced, and claims priority to Provisional Application No. 60/314,822 filed on Aug. 24, 2001. The present invention is also cross-reference to Attorney Docket No. 201-0967 entitled “Method And System For Capturing Vehicle Data Using An RF Transmitter” filed concurrently herewith.

### BACKGROUND OF INVENTION

The present invention relates to collecting data from a vehicle and more particularly to collecting data in real time without manual intervention.

Many applications require the collection of data from a vehicle. Applications in the manufacturing and delivery processes, dealer service processes, rental processes, exporting, fleet processing and credit support are a few examples of the need for data collection.

The data may include, but is not limited to, information relative to a vehicle such as the Vehicle Identification Number, mileage, etc. Currently data collection techniques require either manual collection of data, or a direct electronic connection.

There is a need for an automated method of collecting data from a vehicle that does not require mechanical or electrical intervention. An automated method would significantly increase the accuracy of the data collection process.

### SUMMARY OF INVENTION

The present invention is a system and method for automatic recording of real time data without manual intervention. The present invention reduces the possibility of errors in the collected data and at the same time increases data gathering capabilities.

It is an object of the present invention to collect data from a vehicle. It is another object of the present invention to improve the accuracy and increase the capabilities of data gathering techniques.

It is a further object of the present invention to utilize a telemetry transmitter on the vehicle to automate the capture of relevant data from the vehicle for a variety of manufacturing and service processes.

Other advantages and features of the present invention will become apparent when viewed in light of the detailed description of the preferred embodiment when taken in conjunction with the attached drawings and appended claims.

### BRIEF DESCRIPTION OF DRAWINGS

FIG. 1 is a block diagram of the system used with the inventory management method of the present invention; and

FIG. 2 is a flow diagram of the method used with the inventory management method of the present invention;

FIG. 3 is flow diagram of a supply chain process that utilizes the inventory management method of the present invention.

### DETAILED DESCRIPTION

The present invention is a method for automated collection of data and tracking of transportation vehicles from assembly to receipt at dealers, fleet sites and rental sites. The applications for such a method are too numerous to mention herein, but may include manufacturing applications, finished vehicle delivery processes, dealer service processes, rental processes, export of finished vehicles, fleet processes, and other applications that may support credit operations. In general the present invention relates to inventory management.

The method of the present invention can be applied at many stages and destinations during the vehicle delivery process. While the present invention is being described herein to automotive vehicles, it should be noted that it is not limited to particular application. Any transportation vehicle inventory management system may benefit from the advantages provided by the method of the present invention.

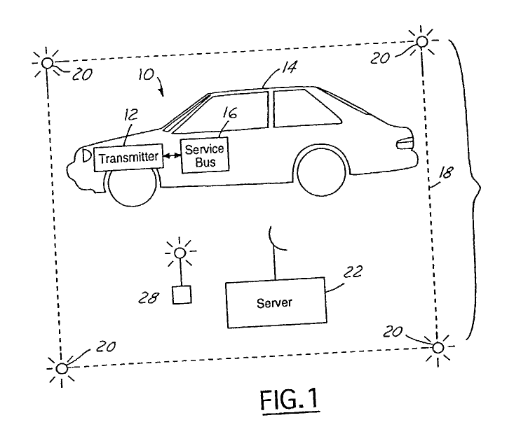

In order to describe the inventory management system of the present invention, reference must be made to an active transmitter system. Referring now to FIG. 1, there is shown a block diagram representing the system and method of data collection used to realize the automated inventory management method of the present invention. This information is taken from Attorney Docket No. 201-0967 entitled “Method And System For Capturing Vehicle Data Using An RF Transmitter” filed concurrently herewith and incorporated by reference herein. An active RF transmitter 12 is mounted to a transportation vehicle 14. The transmitter 12 is connected to a service bus 16, also on the vehicle 14 and is typically used as a port for diagnostic testing of the vehicle. A perimeter 18, or area, is defined by a plurality of wireless antennae 20.

The transmitter 12 has the capability, through software or otherwise, to collect relevant data from the vehicle by way of the service bus 16. The service bus 16 provides the transmitter 12 with the access necessary for collecting relevant information from the vehicle. The desired data has an address that can be accessed by the transmitter through the service plug 16. Typically, a vehicle manufacturer assigns codes to specific events that occur in the electronic infrastructure of the vehicle. These codes are used by the transmitter to access and retrieve the relevant data. The data is communicated to the server where it is translated into useful information.

Relevant data might be the vehicle identification number, the mileage of the vehicle, the battery charge level, the fuel level. It should be noted that other useful and relevant information may be collected and is dependent upon the specific needs for a particular application and a particular type of transportation vehicle. The transmitter 12, by way of the service bus 16, may be programmed to collect any data that is available through the service bus 16.

The transmitter 12 will communicate the data through wireless antennas 20 to a server 22 where the data is collected, and processed for retrieval. The data may be processed and presented in any form that is required for any number of applications through software, or other, manipulation of the transmitted data.

The transmitter 12 can be instructed to collect and deliver to the server 22 as long as the vehicle 14 is within the defined service area 18. The service area shown in FIG. 1 is a square perimeter 18 defined by the wireless antennas 20 for transmitting the data from the transmitter 12 to the server 18. It should be noted that this particular arrangement is shown for example purposes only and several variations can be realized without departing from the scope of this invention. For example, the perimeter need not be square and may be defined by more, or fewer, antennas.

While the transmitter 12 and the server 22 are in continuous communication with each other in real time, it is possible to vary this aspect without departing from the scope of the present invention. For example, in another embodiment of the present invention, a handheld antenna unit 28 may be used to communicate directly with the transmitter 12 and obtain information from a specific vehicle directly to the handheld antenna unit 28.

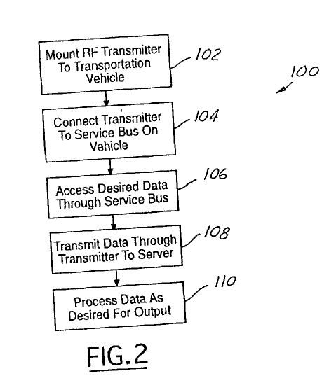

The method 100 is shown in FIG. 2. The method combines the transmitter, the diagnostic service bus and the software necessary for the communication among the transmitter, the service bus and the server to collect and communicate relevant data from the transportation vehicle. The present invention is completely automated in that it does not require any intervention to retrieve the data from the vehicle and communicate it to the server. The data can be transmitted to the server at a predefined distance from the location of the vehicle, eliminating the need for an individual to physically retrieve desired data from the vehicle.

The transmitter is mounted 102 to the vehicle and connected 104 to the service bus on the vehicle. The desired data is accessed 106 by the transmitter through the service bus, and transmitted 108 to the server. The server processes 110 the data and presents it in the output desired for the particular application.

The transmitter and the server are in continuous communication. The antenna unit 28 may be a fixed position device or it may be a handheld unit. The handheld or fixed unit 28 communicates directly with a particular transmitter 12 and forces that particular transmitter 12 to transmit to the handheld unit 28 on demand. The handheld unit 28 may be considered a portable server.

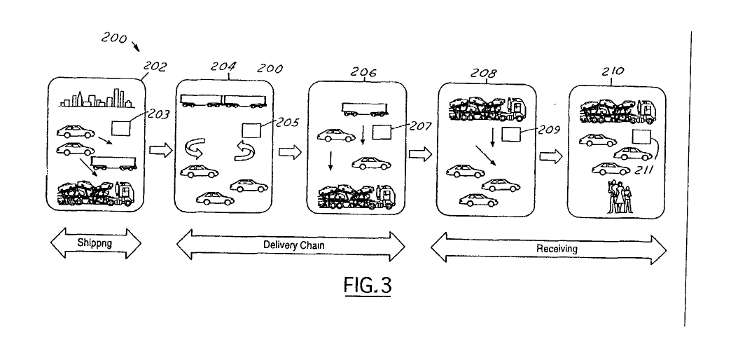

For the present invention, shown in FIG. 3, the inventory management method uses the wireless transmitter system and method to implement a method 200 of tracking a vehicle through the supply chain to obtain real time and automatic data collection for transportation vehicles from shipping, to delivery, to receiving. It is also possible with the present invention to track vehicle service records, mileage, etc. at fleet and rental sites in addition to tracking inventory.

For inventory management, the transmitter is used to track the real-time location of the vehicle during its stay at a particular site. It is also possible to time-stamp the date the vehicle arrived at a particular site and the date a vehicle left a particular site for history or quality concerns.

Beginning at an assembly plant, a service area 202 is defined at the assembly plant site and the shipping yard. A transmitter 12 is mounted to the vehicle 14 at some point near the end of the assembly process. A server 203 at the assembly plant service area 202 is in continuous communication with the transmitter 12 making it possible to easily track its progress from the end of the assembly line, to the shipping yard, and onto a delivery vehicle. At this stage in the process, it is desirable to at least track the vehicle identification number and the vehicle”s location within the site.

In addition, the vehicle may be tagged for quality concerns, special processing, etc. and this information is easily tracked by the continuous transmissions between the transmitter mounted to the vehicle and the server. The server stores the relevant information taken from the vehicle as it progresses through to shipping. It is possible, without having to manually track and enter information, to determine the exact location of the vehicle at any point in time during its stay at the assembly plant and shipping yard.

Typically, several assembly plants, say twenty for example, send their finished vehicles to a few mixing centers. An example would be four mixing centers that receive vehicles from twenty assembly plants. The mixing center collocates vehicles from the assembly plants and divides them for distribution to their final destination.

The inventory management method of the present invention makes it easy for the assembly plant to identify the vehicles that are to go to a particular mixing center for distribution. In addition, applying the inventory management method at the mixing center greatly increases the efficiencies of tracking and distributing vehicles to the shippers.

A mixing center would have a service area 204 defined by an antenna communication system, and each mixing center would have its own server 205. The transmitter 12 on the vehicle 14 and the server 205 at the mixing center are in continuous communication once the vehicle 14 is within the mixing center”s service area 204. Given the continuous communication, the inventory at the mixing center is easily tracked at any point in time. This allows for a continuous flow of vehicles off an arriving railcar and onto another railcar that is being loaded to transport the vehicles to their final destination. In addition, it is possible to determine a vehicle”s dwell time at the mixing center, which is useful information for sales and marketing, as well as inventory control.

After leaving the mixing center, the vehicles are collected at a destination ramp where they are separated and loaded for delivery to dealerships. Each destination ramp has a service area 206 defined by a wireless antenna system and a server 207. Therefore, once the vehicle 14 and its associated transmitter 12 arrive in the destination ramp service area, the vehicle 14 is easily tracked, sorted and sent on the most efficient load available to a dealership.

At the dealership, a service area 208 is defined by its own antenna system and server 209. Once the vehicle 14 arrives at the dealer, the server 209 is in continuous communication with the transmitter 12. It is, therefore, possible to check dealer inventory in real time. Another application of the system at the dealer includes using the transmitter/server system to track vehicles in the service department.

Once a vehicle leaves the dealer, the transmitter should be removed as inventory control is no longer necessary. However, in the event of fleet sites and rental sites, the transmitters may be used for inventory management as well as vehicle service management.

A fleet, or rental, site will have its own service area 210 defined by an antenna system and will have its own server 211. The transmitters on the vehicles within the site are in continuous communication with the server.

Up until this point, it was sufficient to track the vehicle identification number and the location of the vehicle. At this stage, it becomes advantageous to retrieve more data from the vehicle. For example, obtaining the mileage and the fuel level in addition to the vehicle identification number would provide for instantaneous check out and check in at the site.

As far as service of the fleet, additional information such as the battery charge level, service history etc. may also be retrieved and transmitted to the server, thereby increasing the efficiency of service management at the fleet or rental site.

It is clear that the applications to inventory and service management according to the present invention are virtually boundless. As long as a vehicle having a transmitter is within a predefined service area, the transmitter and the server are in communication. Any data desired from the vehicle is easily accessed using the server and transmitter without the need for manual intervention. The present invention eliminates the possibility for error when recording mileage, fuel levels, vehicle identification numbers, etc., thereby greatly enhancing the efficiency of inventory and service management.

While particular embodiments of the invention have been shown and described, numerous variations and alternate embodiments will occur to those skilled in the art. Accordingly, it is intended that the invention be limited only in terms of the appended claims.

1. A method for inventory management of a plurality of transportation vehicles wherein each vehicle has an active RF transmitter in communication with a diagnostic service bus on said vehicle, said method comprising the steps of:
defining a service area for active transmission between said RF transmitter and a server specific to said service area;
communicating data relevant to said transportation vehicle from said transmitter to said server automatically and in real time; and
determining an inventory of transportation vehicles within said predefined service area.

2. The method as claimed in claim 1 further comprising the step of communicating a time said vehicle entered said predefined service area to said server.

3. The method as claimed in claim 1 further comprising the step of communicating a time said vehicle left said predefined service area to said server.

4. The method as claimed in claim 1 further comprising the steps of:
communicating a time said vehicle entered said predefined service area to said server; and
communicating a time said vehicle left said predefined service area to said server.

5. The method as claimed in claim 1 further comprising the steps of:
determining a location of a predetermined number of vehicles having predetermined characteristics, including a destination site; and
delivering said predetermined number of vehicles to said destination site.

6. A method for service management of a plurality of transportation vehicles wherein each vehicle has an active RF transmitter in communication with a diagnostic service bus on said vehicle, said method comprising the steps of:
defining a service area for active transmission between said RF transmitter and a server specific to said service area;
communicating data relevant to said transportation vehicle from said transmitter to said server automatically and in real time; and
determining if a service procedure is necessary on said vehicle based on said communicated data.

7. The method as claimed in claim 6 further comprising the steps of:
communicating a time said vehicle entered said predefined service area to said server; and
communicating a time said vehicle left said predefined service area to said server.

8. A method for automated check-in of a rental vehicle having an active transmitter at a rental vehicle site having a service area defined by an antenna communication system and a server, said method comprising the steps of:
communicating a vehicle identification number of said rental vehicle upon said rental vehicle entering said predefined service area to said server;
communicating a fuel level of said rental vehicle to said server; and
communicating a mileage of said rental vehicle to said server.

9. The method as claimed in claim 8 further comprising the step of determining necessary service procedures for said rental vehicle upon check-in.

10. The method as claimed in claim 9 further comprising the step of identifying said rental vehicle for preparation to be rented again.
